(19) United States
(12) Patent Application Publication
(10) Pub. No.: US 2010/0272978 A1
(43) Pub. Date: Oct. 28, 2010

(54) CARBON FIBERS AND FILMS AND METHODS OF MAKING SAME

(75) Inventors: Satish Kumar, Atlanta, GA (US); Han Gi Chae, Atlanta, GA (US); Young Ho Choi, Atlanta, GA (US)

Correspondence Address: TROUTMAN SANDERS LLP;5200 BANK OF AMERICA PLAZA, 600 PEACHTREE STREET, N.E., SUITE 5200, ATLANTA, GA, 30308-2216, US

(73) Assignee: Georgia Tech Research Corporation, Atlanta, GA (US)

(21) Appl. No.: 12/682,588

(22) PCT Filed: Oct. 10, 2008
(86) PCT No.: PCT/US08/79536

§ 371 Date: Apr. 9, 2010

Related U.S. Application Data
(60) Provisional application No. 60/979,146, filed on Oct. 11, 2007.

(51) Int. Cl. D01F 9/10; D01F 9/22; B29C 55/00; D01F 9/12

(52) U.S. Cl. 428/220; 428/367; 264/210.1; 264/29.2; 977/742; 977/842

(57) ABSTRACT

The various embodiments of the present invention provide improved carbon fibers and films, as well as methods of making the carbon fibers and films. The carbon fibers and films disclosed herein are generally formed from an acrylonitrile-containing polymer. The carbon fibers and/or films can also be formed from a composite that includes the acrylonitrile-containing polymer as well as carbon nanotubes, graphite sheets, or both. The fibers and films described herein can be tailored to exhibit one or more of high strength, high modulus, high electrical conductivity, high thermal conductivity, or optical transparency, depending on the desired application for the fibers or films.

### CROSS-REFERENCE TO RELATED APPLICATIONS

This application claims the benefit of U.S. Provisional Patent Application No. 60/979,146, filed 11 Oct. 2007, which is incorporated herein by reference in its entirety as if fully set forth below.

### STATEMENT OF FEDERALLY SPONSORED RESEARCH

This invention was made with United States Government support under Grant No. FA9550-07-1-0233, awarded by the Air Force Office of Scientific Research. The United States Government has certain rights in this invention.

### TECHNICAL FIELD

The various embodiments of the present invention relate generally to carbon fibers and films, and more particularly, to carbon fibers and films formed from acrylonitrile-containing polymers, and methods of making the carbon fibers and films.

### BACKGROUND

Polymers containing acrylonitrile are important commercial polymers for use in fibers for such applications as fabrics, carpets, and carbon fibers. Acrylic fibers produced from polyacrylonitrile copolymers are currently the predominant precursors for carbon fibers, in part because polyacrylonitrile-based carbon fibers exhibit good tensile and compressive properties.

Recently, methodologies have been developed to produce nanotube-containing polymer composites, and, in particular, carbon fibers containing carbon nanotubes (CNTs), wherein the CNTs are well dispersed in the composite. For example, U.S. Pat. No. 6,852,410, the entire contents of which are incorporated herein by reference as if fully set forth below, discloses such methods. Among other improvements, these methods provide composite fibers with increased tensile modulus and strength. As new applications continue to open up, however, so to does the need for improved materials.

Accordingly, there is a need for new carbon fibers and carbon films that exhibit increased tensile modulus and strength. There is also a need for new methods of making the carbon fibers and films. It is to the provision of such materials and methods that the various embodiments of the present invention are directed.

### BRIEF SUMMARY

The various embodiments of the present invention are directed to carbon fibers and films, and methods of making the carbon fibers and films. The high strength and high modulus fibers and films can be useful in a variety of applications, including, but not limited to, material reinforcement (e.g., in tire cord and in cement), aircraft parts, body panels for high-performance vehicles (e.g., formula one race cars and motorcycles), sporting equipment (e.g., bikes, golf clubs, tennis rackets, and skis), and other demanding mechanical applications. Owing to their electrical and thermal conductivities, these carbon films and fibers can also find applications in electronic devices, fuel cells, electrochemical capacitors, and the like.

Broadly described, methods for making carbon fibers according to various embodiments of the present invention include extruding a solution of a primary component and a solution of a secondary component through a bi-component extrusion apparatus to form a bi-component polymer fiber, which has a primary component and a secondary component, and drawing the bi-component polymer fiber to form a drawn bi-component polymer fiber. The primary component generally includes an acrylonitrile-containing polymer. In some cases, the extruding can be accomplished by gel-extruding or by solution-extruding.

The methods can also include stabilizing the drawn bi-component polymer fiber. The stabilizing can be accomplished under tension, and/or in an oxidizing environment, and/or at about 200 degrees Celsius to about 400 degrees Celsius for less than or equal to about 36 hours. The methods can also include carbonizing the stabilized polymer fiber. The carbonizing can be accomplished under tension, and/or in an inert environment, and/or at about 500 degrees Celsius to about 1800 degrees Celsius for less than or equal to about 2 hours. Still further, the methods can also include graphitizing the carbonized polymer fiber. The graphitizing can be accomplished under tension, and/or in a non-nitrogen-containing inert environment, and/or at about 1800 degrees Celsius to about 2800 degrees Celsius for less than or equal to about 1 hour.

The process can also include separating the primary component from the secondary component of the drawn or stabilized bi-component polymer fiber. The separating can be accomplished by dissolving the secondary component from the drawn or stabilized bi-component polymer fiber, sonicating the drawn or stabilized bi-component polymer fiber to reduce any interfacial interactions between the primary component and secondary component, heating to melt the second component away from the drawn or stabilized bi-component polymer fiber, heating to burn the second component away from the drawn or stabilized bi-component polymer fiber, or a combination that includes at least two of the foregoing. It is also possible for the stabilizing and the separating to occur simultaneously.

After drawing, the drawn polymer fiber can have an average diameter of about 100 nanometers to about 1 millimeter. The final carbon fiber can have an average diameter of about 10 nanometers to about 10 micrometers.

Various other embodiments of the present invention are directed to methods of making carbon fibers or films containing carbon nanotubes (CNTs). These methods include contacting CNTs with an acrylonitrile-containing polymer to form a primary component solution, extruding the primary component solution and a secondary component solution to form a bi-component polymer-CNT fiber or film precursor that includes a primary component and a secondary component, and drawing the bi-component polymer-CNT fiber or film precursor to form a drawn bi-component polymer-CNT fiber or film.

These methods can also include stabilizing the drawn bi-component polymer-CNT fiber or film, separating the primary component from the secondary component of the drawn or stabilized bi-component polymer-CNT fiber or film, carbonizing the stabilized polymer-CNT fiber or film and/or graphitizing the carbonized polymer-CNT fiber or film. Such methods can produce carbon fibers or films that exhibit electrical conductivities at least 25% higher than those for carbon fibers or films containing no CNTs. The methods can also produce carbon fibers or films that have at least an 0.5 GPa greater tensile strength than a carbon fiber or film produced without the CNT. The carbon fiber or film can have at least a 50 GPa greater tensile modulus than a carbon fiber or film produced without the CNT.

In specific embodiments, the CNTs can include single wall nanotubes, double wall nanotubes, triple wall nanotubes, multi-wall (i.e., four or more walls) nanotubes, or a combination having two or more of the foregoing types of CNTs. In some embodiments, the CNTs have an average diameter of about 0.5 nanometers to about 25 nanometers. In other embodiments, the CNTs have an average diameter less than or equal to about 10 nanometers. The CNTs can also have an average length of greater than or equal to about 10 nanometers. The CNTs can take up about 0.001 weight percent to about 40 weight percent of the bi-component polymer-CNT fiber or film precursor. Similarly, the CNTs can encompass about 0.001 weight percent to about 80 weight percent of the final carbon fiber or film, based on a total weight of the carbon fiber or film.

The overall drawn polymer-CNT fibers can have an average diameter of about 100 nanometers to about 1 millimeter. The final carbon fibers can have an average diameter of about 10 nanometers to about 10 micrometers. Similarly, the drawn polymer-CNT films can have an average thickness of about 50 nanometers to about 50 micrometers. The final carbon films can have an average thickness of about 25 nanometers to about 25 micrometers.

In some embodiments, the CNTs in the final carbon fibers or films are exfoliated. The carbon fibers or films can have a crystallized graphitic regions radially extending about 0.34 nanometers to about 50 nanometers from a wall of each CNT. In some embodiments, the crystallized graphitic regions radially extend at least about 2 nanometers from the wall of each CNT.

Various other embodiments of the present invention are directed to methods of making carbon fibers or films containing graphite sheets. These methods include contacting the graphite sheets with an acrylonitrile-containing polymer to form a primary component solution, extruding the primary component solution and a secondary component solution to form a bi-component polymer-graphite sheet fiber or film precursor that includes a primary component and a secondary component, and drawing the bi-component polymer-graphite sheet fiber or film precursor to form a drawn bi-component polymer-graphite sheet fiber or film.

These methods can also include stabilizing the drawn bi-component polymer-graphite sheet fiber or film, separating the primary component from the secondary component of the drawn or stabilized bi-component polymer-graphite sheet fiber or film, carbonizing the stabilized polymer-graphite sheet fiber or film and/or graphitizing the carbonized polymer-graphite sheet fiber or film. Such methods can produce carbon fibers or films that exhibit electrical conductivities at least 25% higher than those for carbon fibers or films containing no graphite sheets. The methods can also produce carbon fibers or films that have at least an 0.5 GPa greater tensile strength than a carbon fiber or film produced without the graphite sheets. The carbon fiber or film can have at least a 50 GPa greater tensile modulus than a carbon fiber or film produced without the graphite sheets.

In specific embodiments, the graphite sheets can have an average width of about 0.5 nanometers to about 100 nanometers. In other embodiments, the graphite sheets have an average width less than or equal to about 10 nanometers. The graphite sheets can also have an average thickness of about 0.5 nanometers to about 25 nanometers. The graphite sheets can also have an average length of greater than or equal to about 10 nanometers. The graphite sheets can take up about 0.001 weight percent to about 40 weight percent of the bi-component polymer-graphite sheet fiber or film precursor. Similarly, the graphite sheets can encompass about 0.001 weight percent to about 80 weight percent of the final carbon fiber or film, based on a total weight of the carbon fiber or film.

The drawn polymer-graphite sheet fibers can have an average diameter of about 100 nanometers to about 1 millimeter. The final carbon fibers can have an average diameter of about 10 nanometers to about 10 micrometers. Similarly, the drawn polymer-graphite sheet films can have an average thickness of about 50 nanometers to about 50 micrometers. The final carbon films can have an average thickness of about 25 nanometers to about 25 micrometers.

In some embodiments, the graphite sheets in the final carbon fibers or films are exfoliated. The carbon fibers or films can have a crystallized graphitic regions radially extending about 0.34 nanometers to about 50 nanometers from a face of each graphite sheet. In some embodiments, the crystallized graphitic regions radially extend at least about 2 nanometers from the face of each graphite sheet.

Various other embodiments of the present invention are directed to carbon fibers or films. The carbon fibers or films can be formed from CNTs and an acrylonitrile-containing polymer. These carbon fibers can have average diameters of about 10 nanometers to about 10 micrometers; and the carbon films can have average thicknesses of about 25 nanometers to about 25 micrometers. In some instances, the carbon fibers can have an average diameter of less than or equal to about 500 nanometers, while the carbon films can have an average thickness of less than or equal to about 1 micrometer.

Crystallized graphitic regions radially extending about 0.34 nanometers to about 50 nanometers from the wall of each CNT can be found in the carbon fibers or films. In some embodiments, the crystallized graphitic region radially extends at least about 2 nanometers from the wall of each CNT.

The carbon fibers or films can have exfoliated CNTs. The carbon fibers or films can exhibit electrical conductivities at least 25% higher than those for carbon fibers or films containing no CNTs. Depending on the particular dimensions of the fibers or films, in some embodiments they can be optically transparent.

The carbon fibers or films can have tensile strengths at least about 0.65 GPa greater than carbon fibers or films formed without CNTs. The carbon fibers or films can have tensile moduli at least about 75 GPa greater than carbon fibers or films formed without CNTs.

Still other embodiments of the present invention are directed to carbon fibers or films. The carbon fibers or films can be formed from graphite sheets and an acrylonitrile-containing polymer. These carbon fibers have average cross-sectional dimensions of about 10 nanometers to about 10 micrometers; the carbon films have average thicknesses of about 25 nanometers to about 25 micrometers. In some instances, the carbon fibers can have an average diameter of less than or equal to about 500 nanometers, while the carbon films can have an average thickness of less than or equal to about 1 micrometer.

Crystallized graphitic regions radially extending about 0.34 nanometers to about 50 nanometers from a face of the graphite sheets can be found in the carbon fibers or films. In some embodiments, the crystallized graphitic region radially extends at least about 2 nanometers from a face of each graphite sheet.

The carbon fibers or films can have exfoliated graphite sheets. The carbon fibers or films can exhibit electrical conductivities at least 25% higher than those for carbon fibers or films containing no graphite sheets. Depending on the particular dimensions of the fibers or films, in some embodiments they can be optically transparent.

The carbon fibers or films can have tensile strengths at least about 0.65 GPa greater than carbon fibers or films formed without graphite sheets. The carbon fibers or films can have tensile moduli at least about 75 GPa greater than carbon fibers or films formed without graphite sheets.

Other aspects and features of embodiments of the present invention will become apparent to those of ordinary skill in the art, upon reviewing the following detailed description in conjunction with the accompanying figures.

### BRIEF DESCRIPTION OF THE DRAWINGS

FIGS. 1 (a) and (b) are process flow diagrams illustrating methods for making carbon fibers or films in accordance with some embodiments of the present invention.

FIG. 2 is a schematic illustration of a bi-component extrusion apparatus according to some embodiments of the present invention.

FIG. 3 is a schematic illustration of various bi-component fiber geometries according to some embodiments of the present invention.

FIG. 4 is schematic illustration of various bi-component film geometries according to some embodiments of the present invention.

FIG. 5 includes (a) high-resolution transmission electron microscope (HR-TEM) images and (b) a Raman spectrum of pristine CNTs.

FIG. 6 includes scanning electron microscope (SEM) images showing the separation of PAN/CNT island fibers from a PMMA sea component (a) at low magnification and (b) at high magnification.

FIG. 7 is a schematic illustration of an apparatus for inducing stress or tension in fibers during stabilization and carbonization.

FIG. 8 includes stress-strain curves for carbonized PAN and PAN/CNT (99/1) fibers.

FIG. 9 includes tensile strength of carbonized PAN and PAN/CNT fibers as a function of cross-sectional area.

FIG. 10 includes SEM images of fractured surfaces of (a) carbonized PAN island fibers and (b) carbonized PAN/CNT island fibers.

FIG. 11 includes HR-TEM images of (a) carbonized PAN and (b)-(d) carbonized PAN/CNT fibers.

FIG. 12 includes Raman spectra of carbonized island PAN and PAN/CNT (99/1) fibers.

### DETAILED DESCRIPTION

Referring now to the figures, wherein like reference numerals represent like parts throughout the several views, exemplary embodiments of the present invention will be described in detail. Throughout this description, various components may be identified having specific values or parameters, however, these items are provided as exemplary embodiments. Indeed, the exemplary embodiments do not limit the various aspects and concepts of the present invention as many comparable parameters, sizes, ranges, and/or values may be implemented. The terms “first,” “second,” and the like, “primary,” “secondary,” and the like, do not denote any order, quantity, or importance, but rather are used to distinguish one element from another. Further, the terms “a”, “an”, and “the” do not denote a limitation of quantity, but rather denote the presence of “at least one” of the referenced item.

The small diameter carbon fibers and small thickness carbon films disclosed herein are formed from an acrylonitrile-containing polymer. In addition, the carbon fibers and/or carbon films optionally can be formed from a composite comprising the acrylonitrile-containing polymer and carbon nanotubes (CNTs). In other embodiments, the carbon fibers and/or films optionally can be formed from a composite comprising the acrylonitrile-containing polymer and individual or groups of graphite sheets. Incorporating CNTs and/or graphite sheets into the carbon fiber and/or film precursors results in carbon fibers and/or carbon films that exhibit many beneficial properties as will be described in more detail below.

The acrylonitrile-containing polymers that are used to make the small dimensioned (i.e., small diameter or thickness) carbon fibers or films described herein can include copolymers containing an acrylonitrile monomer and another (i.e., at least one other) monomer. Thus, the term “copolymer” also includes terpolymers and other polymers having more than two different monomers. Examples of acrylonitrile-containing polymers include, but are not limited to, polyacrylonitrile (PAN), poly(acrylonitrile-methyl acrylate), poly(acrylonitrile-methacrylic acid), poly(acrylonitrile-acrylic acid), poly(acrylonitrile-itaconic acid), poly(acrylonitrile-methyl methacrylate), poly(acrylonitrile-itaconic acid-methyl acrylate), poly(acrylonitrile-methacrylic acid-methyl acrylate), poly(acrylonitrile-vinyl pyridine), poly(acrylonitrile-vinyl chloride), poly(acrylonitrile-vinyl acetate), and combinations thereof.

The relative amounts of co-monomer components in an acrylonitrile copolymer, as well as the molecular weight of the acrylonitrile-containing polymer, are dependent on the fiber or film properties desired. While different amounts can be used, preferably, the acrylonitrile monomer incorporation is greater than about 85 weight percent (wt %) based on the total weight of the overall acrylonitrile-containing polymer. Also, while other ranges can be used, the preferred molecular weight range of an acrylonitrile-containing polymer is about 50,000 grams per mole (g/mole) to about 2,000,000 g/mole, with 100,000 g/mole to about 500,000 g/mole even more preferred.

The carbon nanotubes that are used to make the small dimensioned carbon fibers or films described herein can be any type of carbon nanotube, including single wall nanotubes (SWNTs), double wall nanotubes (DWNTs), triple wall nanotubes (TWNTs), multi-wall carbon nanotubes (MWNTs), or the like, or a combination including two or more of the foregoing types of carbon nanotubes (e.g., mixtures of SWNTs and DWNTs, mixtures of DWNTs and TWNTs, mixtures of SWNTs, DWNTs, and TWNTs, and the like). The CNTs can be tubular or collapsed nanotubes.

The carbon nanotubes can be made from any known means, including, but not limited to, gas-phase synthesis from high temperature, high pressure carbon monoxide, catalytic vapor deposition using carbon-containing feedstocks and metal catalyst particles, laser ablation, arc method, or any other method for synthesizing carbon nanotubes.

The CNTs obtained from synthesis are generally in the form of a powder, but can also be used in the form of carpets, forests, pearls, or like arrangements. The average diameter of the nanotubes can be about 0.5 nanometers (nm) to about 25 nm, with about 0.5 nm to about 10 nm being preferable. In some embodiments, it is desirable to use nanotubes having an average diameter of less than or equal to about 10 nm. The average length of the nanotubes can be greater than or equal to about 10 nanometers. For example, nanotubes having lengths on the order of millimeters or even centimeters could be used.

It is desirable for the CNTs to have a purity of at least 95 percent (%), and preferably at least 99%, in order to minimize the potential for adverse affects caused by impurities within the CNT sample. Thus, the CNTs can optionally be purified to remove non-nanotube carbon, such as amorphous carbon, and metallic catalyst residues.

Purification can be achieved by any known means. Procedures for purification of carbon nanotubes are well known to those skilled in the art to which this disclosure pertains. The optionally purified CNTs can also be dried. Similarly, procedures for drying are well known to those skilled in the art to which this disclosure pertains.

Further, the CNTs can be optionally derivatized on their ends and/or sides with a functional group. These functional groups can include an alkyl; acyl; aryl; aralkyl; halogen; substituted or unsubstituted thiol; substituted or unsubstituted amino; hydroxyl; an OR′ wherein R′ can include an alkyl, acyl, aryl, aralkyl, substituted or unsubstituted amino, substituted or unsubstituted thiol, and halogen; or a linear or cyclic carbon chain optionally interrupted with one or more heteroatom, and optionally substituted with one or more ═O, or ═S, hydroxyl, aminoalkyl group, amino acid, or a peptide. The extent of the substitution can be tailored to achieve the desired chemical effect, as would be understood to those skilled in the art to which this disclosure pertains. By way of one example, the number of carbon atoms in the alkyl, acyl, aryl, aralkyl groups can be in the range of 1 to about 30.

The CNTs can also optionally include non-carbon elements in the backbone. For example, elements such as boron, nitrogen, sulfur, silicon, or the like, can be included in the backbone of the CNTs depending on the particular application for the carbon fibers or films.

Similarly, the graphite sheets that are used to make the small dimensioned carbon fibers or films described herein can be made from any known synthesis means. The average width of the graphite sheets can be about 0.5 nanometers (nm) to about 100 nm, with about 0.5 nm to about 50 nm being preferable. In some embodiments, it is desirable to use graphite sheets having an average width of less than or equal to about 10 nm. The average length of the graphite sheets can be greater than or equal to about 10 nanometers. For example, graphite sheets having lengths on the order of millimeters or even centimeters could be used. The average thickness of the graphite sheets can be about 0.5 nm to about 25 nm, with about 0.5 nm to about 10 nm being preferable. When groups of graphite sheets are used to make the small dimensioned carbon fibers or films, there can be as many as 75 graphite sheets in a group.

In a similar fashion to the CNTs, the graphite sheets are desirably purified so as to minimize the potential for adverse affects caused by impurities within the graphite sample. Just as with the carbon nanotubes, the graphite sheets can be derivatized and/or include non-carbon elements in the framework. The optional derivatization and incorporation of non-carbon elements in the framework can be implemented in order to minimize the aggregation of the graphite sheets in the carbon fibers or films.

As will now be described, the small dimensions of the carbon fibers and films can be achieved by preparing multi-component, or conjugate, fibers or films from which the desired small dimensioned fibers or films can be obtained. The use of multi-component fiber or film processing overcomes the dimensional limitations of current fiber or film processing equipment while also offering the potential to retrieve a plurality of small dimensioned fibers or films from a single multi-component fiber or film.

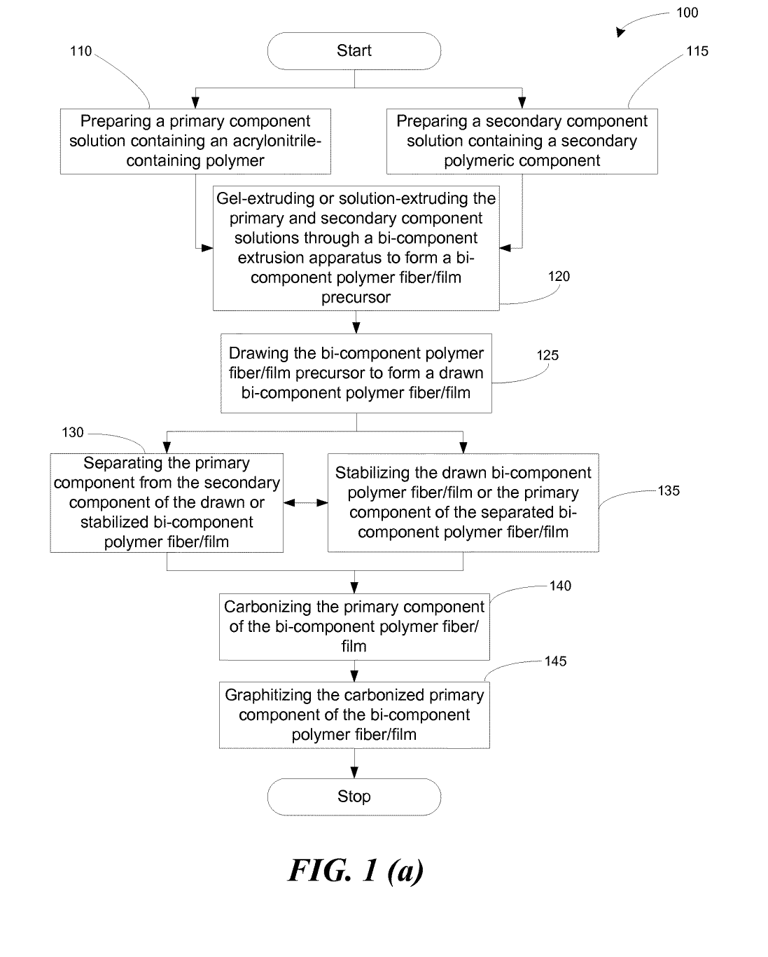

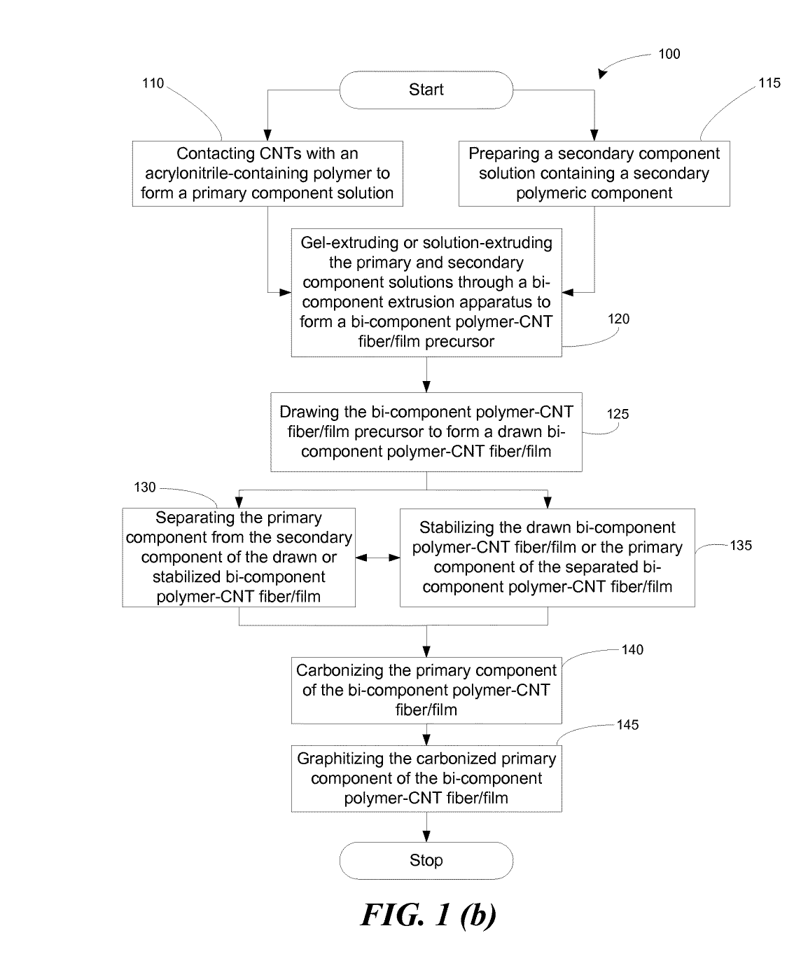

Referring now to FIGS. 1(a) and (b), processes, generically designated 100, for manufacturing carbon fibers or films having small diameters or thicknesses, respectively, in accordance with some embodiments of the present invention are shown. For convenience and simplicity, the processes shown in FIGS. 1 (a) and (b) make reference to a bi-component system. It is to be understood that more than two components can exist in the multi-component fibers or films. Thus, while reference is made to a secondary component, the processing of a tertiary component, quaternary component, and so on, as shown in the figures and as described below for the secondary component is also contemplated for the tertiary component, quaternary component, and so on.

FIG. 1(a) illustrates a process for manufacturing carbon fibers or films from an acrylonitrile-containing polymer without including CNTs or graphite sheets. The process 100 begins at 120, where separate solutions, each independently containing a primary component and a secondary component of the bi-component fiber or film are gel- or solution-extruded through a bi-component extrusion apparatus to form a bi-component polymer fiber or film precursor. The process 100 can also include preparation of the solutions of the primary component and secondary component, which are depicted as 110 and 115, respectively; or the solutions can be pre-fabricated. The primary component includes the acrylonitrile-containing polymer. The bi-component polymer fiber precursor or a polymer film precursor, can then be drawn 125 to form a drawn bi-component polymer fiber or drawn polymer film, respectively.

Next, and shown as 130, the primary component of the drawn bi-component fiber or film can be separated from the secondary component of the drawn bi-component polymer fiber or film. After separation, the primary component of the drawn bi-component polymer fiber or film can be thermally stabilized, which is shown as 135. Finally, depicted as 140 and 145, the stabilized primary component polymer fiber or film can be carbonized and graphitized, respectively, to form the final carbon fiber or film.

Alternatively, the bi-component polymer fiber or film can be thermally stabilized 135 after being drawn 125. Once stabilized, the bi-component fiber or film can then be separated 130. After the separation 130, the primary component of the bi-component fiber or film can be carbonized 140. Ultimately, after carbonization 140, the primary component of the bi-component fiber or film can be graphitized 145.

It is also possible, as will be described in more detail below, for the stabilization 135 to cause the primary component to be separated from the secondary component owing to the temperatures to which the bi-component polymer fiber or film is subjected during the stabilization 135. In these embodiments, the primary component of the bi-component polymer fiber or film can be carbonized 140 after stabilizing 135 the drawn bi-component polymer fiber or film, without making use of an actual separation step 130. Again, after carbonization 140, the primary component of the bi-component fiber or film can be graphitized 145 to form the final carbon fiber or film.

In exemplary embodiments, one or more of the gel- or solution-extruding 120, drawing 125, separating 130, stabilizing 135, carbonizing 140, and graphitizing 145 steps are continuous, rather than batch, processes.

FIG. 1(b) illustrates a process for manufacturing carbon fibers or films from a composite containing the acrylonitrile-containing polymer and CNTs and/or graphite sheets. While the process shown in FIG. 1 (b) makes reference to CNTs only, it is to be understood that graphite sheets can be implemented either in place of, or in addition to, the CNTs in the process. Thus, for example, when reference is made to stabilizing 135 a drawn bi-component polymer-CNT fiber or film, a drawn bi-component polymer-graphite sheet fiber or film, or a drawn polymer-CNT/graphite sheet fiber or film, can also be stabilized 135 under the process conditions shown in the figure and described below.

The process shown in FIG. 1(b) 100 begins at 120, where separate solutions, each independently containing a primary component and a secondary component of the bi-component fiber or film are extruded through a bi-component extrusion apparatus to form a bi-component polymer-CNT fiber or film precursor. The process 100 can also include preparation of the solutions of the primary component and secondary component, which are depicted as 110 and 115, respectively; or the solutions can be pre-fabricated. The primary component in this process includes the acrylonitrile-containing polymer and the CNTs (whether as-synthesized, purified, or derivatized). The solution of the primary component is fabricated by contacting the CNTs with the acrylonitrile-containing polymer. This solution can be thought of as a polymer-CNT dope. Next, The bi-component polymer-CNT fiber or film precursor, can then be drawn 125 to form a drawn bi-component polymer-CNT fiber or film, respectively.

The variations in the order of the process shown in FIG. 1(a) apply to the process 100 shown in FIG. 1 (b) too. Thus, after drawing 125, process 100 can proceed to separating 130, stabilizing 135, carbonizing 140, and graphitizing 145; stabilizing 135, separating 130, carbonizing 140, and graphitizing 145; or stabilizing 135, carbonizing 140, and graphitizing 145. Just as for the process shown in FIG. 1(a), in exemplary embodiments, one or more of the extruding 120, drawing 125, separating 130, stabilizing 135, carbonizing 140, and graphitizing 145 steps are continuous process steps.

The processes shown in FIGS. 1 (a) and (b) are intended to produce carbon fibers or films having small diameters or thicknesses, respectively. It should be noted, however, that microscopic fibers or films having these small diameters or thicknesses, respectively, can be collected from either process after the drawing 125 or stabilizing 135 steps. Thus, for these embodiments, the processes do not include at least the carbonizing 140 and graphitizing 145 steps.

Hereinbelow, the various process steps will be described with reference to the process illustrated in FIG. 1(b). It will be understood, however, that with the exception of preparing the solution of the primary component 110, the steps described below are equally applicable to the process shown in FIG. 1(a) (i.e., for making carbon fibers or films using an acrylonitrile-containing polymer without CNTs and/or graphite sheets) without departure from the details and parameters provided below. Thus, for example, when reference is made to stabilizing 135 a drawn bi-component polymer-CNT fiber or film, a drawn bi-component polymer (without CNTs and/or graphite sheets) fiber or film can also be stabilized 135 under the general conditions encompassed by the parameters described below. It will equally be understood that any reference to amounts, ratios, and the like of CNTs only refer to the process illustrated in FIG. 1 (b). For the sake of brevity (i.e., to minimize repetition of text wherein process steps, conditions, amounts, ratios, and the like are described relative to CNTs are again described for graphite sheets), it is to be understood that, by extension, all reference to CNTs is intended to include graphite sheets, whether used as a substitute for CNTs or in conjunction with CNTs.

To prepare the solution of the primary component 110, which is accomplished by contacting CNTs with the acrylonitrile-containing polymer, the CNTs (and/or, by extension, the graphite sheets) can be first dispersed in a solvent, followed by addition of the acrylonitrile-containing polymer. Alternatively, the CNTs and the acrylonitrile-containing polymer can be mixed simultaneously (i.e., rather than stepwise) in the solvent. In another alternative, the acrylonitrile-containing polymer can be first dispersed in a solvent, followed by addition of the CNTs, which can be dry or dispersed in the same or a different solvent as well. In yet another alternative, the CNTs can be combined with the acrylonitrile-containing polymer in a melt. In still another alternative, dry CNTs or CNTs in solution can be added to the acrylonitrile-containing polymer while the acrylonitrile-containing polymer is at the monomer stage, or at any time during the polymerization that results in the acrylonitrile-containing polymer.

The solvent is desirably one that can solubilize (i.e., render at least partially soluble) both CNTs and acrylonitrile-containing polymers. Dimethyl formamide (DMF) and dimethyl acetamide (DMAc) are exemplary solvents that can be used to suspend or solubilize polyacrylonitrile polymers and copolymers. Other examples of organic solvents that can be used to suspend or solubilize polyacrylonitrile polymers and copolymers include, but are not limited to, dimethylsulfoxide (DMSO), ethylene carbonate, dioxanone, chloroacetonitrile, dimethyl sulfone, propylene carbonate, malononitrile, succinonitrile, adiponitrile, γ-butyrolactone, acetic anhydride, ε-caprolactam, bis(2-cyanoethyl)ether, bis(4-cyanobutyl)sulfone, chloroacetonitrile/water, chloroacetonitrile, cyanoacetic acid, dimethyl phosphate, tetramethylene sulfoxide, glutaronitrile, succinonitrile, N-formylhexamethyleneimine, 2-hydroxyethyl methyl sulfone, N-methyl-β-cyanoethylformamide, methylene dithiocyanate, N-methyl-α,α,α,-trifluoroacetamide, 1-methyl-2-pyridone, 3,4-nitrophenol, nitromethane/water (94:6), N-nitrosopiperidine, 2-oxazolidone, 1,3,3,5-tetracyanopentane, 1,1,1-trichloro-3-nitro-2-propane, and p-phenol-sulfonic acid. Examples of inorganic solvents include, but are not limited to, aqueous concentrated acids, such as concentrated nitric acid (approximately 69.5 wt % HNO₃), concentrated sulfuric acid (approximately 96 wt % H₂SO₄), and the like; and concentrated salt solutions, such as zinc chloride, lithium bromide, sodium thiocyanate, and the like.

Mixing techniques or means to disperse the nanotubes and/or the acrylonitrile-containing polymer in the solvent include, but are not limited to, sonication (e.g., with a bath sonicator or a probe sonicator), homogenation (e.g., with a bio-homogenizer), mechanical stifling (e.g., with a magnetic stifling bar), high shear mixing techniques, extrusion (e.g., single- or multiple-screw), and the like. In some embodiments, heat can be applied to facilitate dispersing the CNTs and/or the acrylonitrile-containing polymer in the solvent. Generally, heat can be applied up to the boiling point of the solvent.

The time of mixing is dependent on various parameters, including, but not limited to, the solvent, temperature of the mixture, concentration of the nanotubes and/or the acrylonitrile-containing polymer, and mixing technique. The mixing time is the time needed to prepare a generally homogeneous suspension or dispersion.

After dispersing the CNTs and/or acrylonitrile-containing polymer in the selected solvent to form a suspension, some of the solvent can optionally be removed. Solvent removal can be achieved by any known means, such as with the application of heat, application of a vacuum, ambient solvent evaporation, or the like. The time and temperature needed to adjust the concentration of the solvent in the suspension are dependent on various parameters, including, but not limited to, the particular solvent used, the amount of solvent to be removed, and the nature of the solvent.

The acrylonitrile-containing polymer concentration in the particular solvent is dependent on various factors, one of which is the molecular weight of the acrylonitrile-containing polymer. The concentration of the polymer solution is selected to provide a viscosity conducive to the selected fiber or film extruding technique. Generally, with respect to the preparation of a polymer solution, the polymer molecular weight and polymer concentration are inversely related. In other words, the higher the molecular weight of the polymer, the lower the concentration of polymer needed to obtain the desired viscosity. By way of example, solutions up to about 25 wt % could be made with an acrylonitrile-containing polymer, in DMF or DMAc, having a molecular weight on the order of about 50,000 g/mole; solutions up to about 15 wt % polymer could be made with an acrylonitrile-containing polymer having a molecular weight of about 250,000 g/mole; and solutions up to about 5 wt % could be made with an acrylonitrile-containing polymer having a molecular weight of about 1,000,000 g/mole. The solution concentrations would also depend on, among other variables, the particular polymer composition, the particular solvent, and solution temperature.

When the acrylonitrile-containing polymer is added to the nanotube-solvent suspension, it is homogenized to form an optically homogeneous polymer-CNT solution or suspension, also called a “dope”. The acrylonitrile-containing polymer can be added all at one time, gradually in a continuous fashion, or stepwise to make the generally homogeneous solution. Mixing of the polymer to make an optically-homogeneous solution can be done using any technique, such as mechanical stifling, sonication, homogenization, high shear mixing, extrusion, or combinations thereof.

Similarly, when the CNTs and the acrylonitrile-containing polymer are mixed with the solvent simultaneously, the three components are mixed to form an optically homogenous polymer-CNT dope. Mixing of the nanotubes and polymer to make an optically-homogeneous solution can be done using any technique, such as mechanical stifling, sonication, homogenization, high shear mixing, extrusion, or combinations thereof.

The nanotubes will generally comprise about 0.001 wt % to about 40 wt % of the dope, with about 0.01 wt % to about 5 wt % being preferable.

There is no particular limit on the choice of the secondary component of the bi-component system. Generally, the second component is selected such that it can be extruded and drawn with the first component, but can be separated from the first component in any of a number of ways, which will be described below. Thus, the second component polymer should not cross-link with the acrylonitrile-containing polymer of the first component. Factors that can affect the choice of the secondary component polymer include viscosity, melt temperature, compatibility with the acrylonitrile-containing polymer, rheology, and the like. For example, the viscosities of both polymer components should be of a comparable value. Otherwise, the higher viscosity component will oppose rearrangement during the extruding step, and cause the distortion of the distribution of the components in the cross section of the fiber or film. Similarly, in situations where heat will be used to separate the two components of the bi-component fiber or film, the second component polymer should not have a melting temperature that is substantially similar to the acrylonitrile-containing polymer of the first component, as it could complicate the separation process. The actual choice of secondary component polymer would be well within the capabilities of those skilled in the art to which this disclosure pertains.

Preparation of the Solution of the Secondary Component can Include Dispersing or dissolving the secondary component polymer in a solvent. The solvent is desirably one that can solubilize the secondary component polymer. In exemplary embodiments, the solvent is the same as that used to prepare the solution of the primary component.

After preparation of the primary component solution and the secondary component solution, the solutions are co-extruded 120 into a polymer-CNT fiber or film. As used herein, the term “extruding” is intended to generically include not only extruding techniques used to make drawable bi-component films, but also spinning techniques used to make drawable bi-component fibers. The extruding step 120 can be effected using any means of making drawable fibers or films. Examples of techniques suitable for making drawable fibers or films include, but are not limited to, gel extruding (which includes gel spinning), wet extruding (which includes wet spinning), dry extruding (which includes dry spinning), dry-jet wet extruding (which includes dry-jet wet spinning), electroextruding (which includes electrospinning), melt extruding (which includes melt spinning), and the like. When extruding a film, a slit shaped die is used. After the component solutions are extruded through the spinneret or die, the fiber or film, respectively, is drawn 125 in a manner consistent with the particular extruding technique used.

In an exemplary embodiment, the technique used to extrude the component solutions is gel extrusion. The polymer concentration, solvent concentration, gelation media, and the gelation time can be varied to effect the desired properties of the drawn fibers or films as would readily be understood by those skilled in the art to which this disclosure pertains.

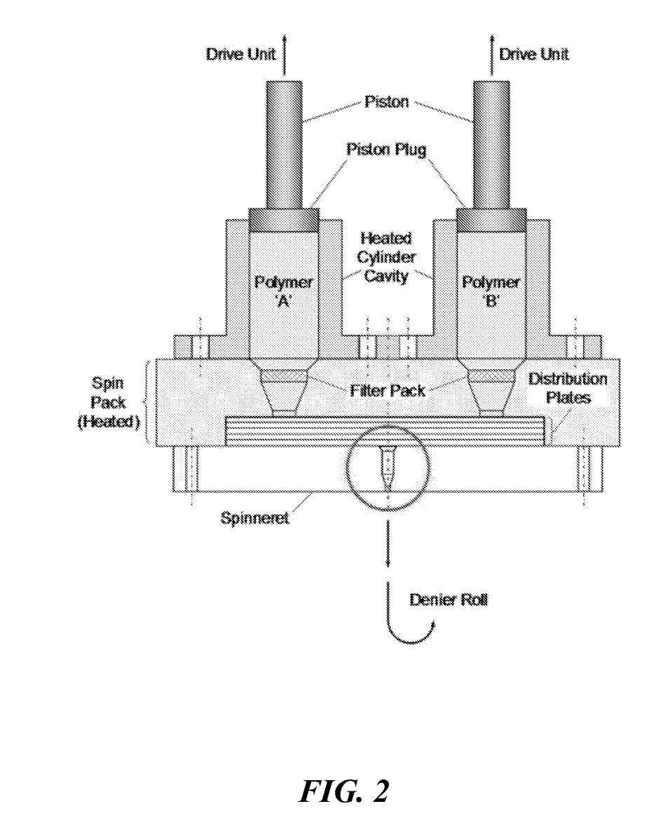

The extrusion 120 is accomplished using a bi-component extrusion apparatus. FIG. 2 provides a schematic illustration of such a device, generally depicted as 200. As shown in the drawing, the solutions of the individual components are introduced into the apparatus 200 independently. The individual solutions can be stored in a chamber that can optionally be heated so as to produce the desired rheological properties of each component solution. The individual solutions can be flowed through a filter to minimize the possibility for impurities in the extruded bi-component fiber or film. After passing through the filter, if desired, the solutions of the individual components are independently fed into a device that controls the distribution or path of flow of each solution. The solutions of the individual components are then passed through the spinneret or die so as to produce the bi-component polymer-CNT fiber or film.

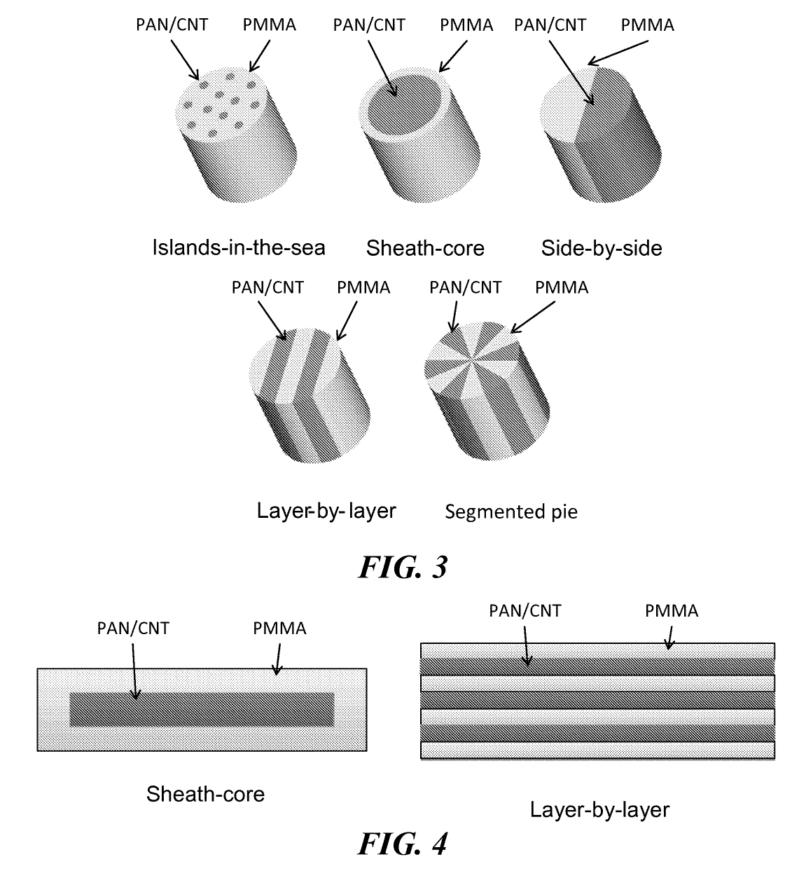

A plurality of extruded bi-component polymer-CNT fiber or film geometries can be obtained. A representative non-limiting group of geometries for fibers and films are shown in FIGS. 3 and 4, respectively. The geometries shown in FIG. 3 include the so-called “island-in-a-sea,” “core-sheath,” “side-by-side,” “layer-by-layer,” and “segmented pie” geometries. The geometries shown in FIG. 4 include the so-called “core-sheath” and “layer-by-layer” geometries.

The specific geometry desired can be produced by tailoring the device that controls the distribution or path of flow of each solution into the spinneret or die. These devices, which are well known and are commercially available, generally contain one or more distributor plates in which distributor flow paths are etched on one or both sides of the plates to distribute the polymer components to appropriate spinneret or die inlet hole locations. The distribution paths can be sufficiently small to facilitate the production of multiple discrete polymer component streams axially into each spinneret or die orifice inlet hole, such that the resulting extruded fiber or film can have the desired geometry. Specific examples of such devices can be found in U.S. Pat. Nos. 5,162,074, 5,344,297, 5,466,410, 5,533,883, 5,551,588, 5,575,063, 5,620,644, and others, all assigned to the BASF corporation, as well as U.S. Pat. Nos. 5,462,653, 5,562,930, and others, all assigned to Hills, Inc.

After extrusion 120, the bi-component polymer-CNT fibers or films can be drawn 125. The diameter or thickness of the drawn overall bi-component polymer-CNT fibers or films (i.e., including both the primary component and secondary component), respectively, can be controlled by the size of the orifice in the spinneret or die. These dimensions can also be controlled by the number of primary components within the fiber or film. The drawn bi-component polymer-CNT fibers can have an average diameter of about 100 nm to about 1 millimeter. More specifically, the drawn bi-component polymer-CNT precursor fibers can have an average diameter of about 100 nm to about 100 micrometers (μm). Analogously, the drawn polymer-CNT film precursor can have an average thickness of about 50 nm to about 500 μm. More specifically, the drawn bi-component polymer-CNT precursor films can have an average thickness of about 100 nm to about 100 μm. Within the drawn bi-component polymer-CNT fiber or film, the CNTs can be tubular or they can be flattened or collapsed. In some embodiments, particularly with CNTs having an average diameter of less than or equal to about 15 nm, the flattened or collapsed CNTs can become unraveled or unwrapped so as to become a graphite sheet having a width of about 0.5 nm to about 100 nm.

The overall drawn bi-component polymer-CNT fibers or films themselves can have desirable properties. For example, the drawn bi-component polymer-CNT fibers or films can have tensile strengths of about 0.25 gigaPascals (GPa) to about 2 GPa. In some instances, the tensile strengths can be at least about 1 GPa. The drawn bi-component polymer-CNT fibers or films can also have an initial tensile modulus of about 15 GPa to about 30 GPa; and, in some cases, the tensile modulus can be at least 25 GPa. The crystallinity of the drawn bi-component polymer-CNT fibers or films can be at least about 50%, and in some cases the crystallinity can be at least about 70%. Finally, the drawn bi-component polymer-CNT fibers or films can have a molecular orientation of at least about 0.75, with some films of fibers having a molecular orientation of at least about 0.9.

After the drawing step 125, the drawn bi-component polymer-CNT fibers or films can be subjected to one of two process steps. The drawn bi-component polymer-CNT fibers or films can be separated 130, or the drawn bi-component polymer-CNT fibers or films can be thermally stabilized 135.

During separation 130, the primary component, comprising the CNTs and the acrylonitrile-containing polymer, is separated from the secondary component of the drawn bi-component polymer-CNT fibers or films. This can be accomplished using a chemical treatment to dissolve the second component polymer, sonication if the interface between the primary component and the secondary component is poor, a mild heat treatment to melt away the second component polymer, a more intense heat treatment to burn away the second component polymer, or the like. After separation 130, the primary component of the bi-component polymer-CNT fiber or film can be stabilized 135 or carbonized 140 (if it has been previously stabilized 135).

Stabilization 135, generally comprises a heat treatment wherein the drawn polymer-CNT fiber or film, whether separated or not, can optionally be placed under stress or tension. The heat treatment occurs in an oxidizing atmosphere. During this oxidative stabilization 135, the acrylonitrile-containing polymer of the primary component undergoes a chemical change that results in it having an increased density. It is believed that, in some embodiments, the stabilization process causes cyclization of the acrylonitrile-containing polymer, leading to what is termed a “ladder polymer.” In addition it is possible for some hydrogen evolution and/or oxygen absorption to occur.

Generally, the stabilization step 135 occurs at about 200° C. to about 400° C. in air, and can last for up to 36 hours, with about 30 seconds to about 24 hours being preferred. The exact temperature and duration depends, in part, on the acrylonitrile-containing polymer composition, the drawn polymer-CNT fiber diameter or film thickness, and whether the second component has been removed previously. In some embodiments, the heat treatment can be a multi-step heat treatment.

Next, the stabilized primary component of the bi-component fibers or films can undergo separation 130 or carbonization 140. Carbonization 140 generally comprises a heat treatment in an inert environment (e.g., nitrogen, helium, argon, and the like) at a more elevated temperature than the stabilization temperature. This step can be performed with the stabilized primary component fibers or films under tension or stress. During carbonization 140, the carbon content of the stabilized primary component fibers or films is increased (e.g., to above 90 wt %), and a three-dimensional carbon structure can form. This generally occurs via pyrolysis.

Generally, the carbonization step 140 occurs at about 500° C. to about 1800° C. Further, the duration can be up to about 2 hours, with about 1 millisecond to about 60 minutes being preferred. The exact temperature and duration can, in part, depend on the acrylonitrile-containing polymer composition and the concentration of CNTs present in the composite. For example, using higher carbonization temperatures can result in an increased modulus. In some embodiments, the heat treatment can be a multi-step heat treatment.

After carbonization 140, the primary component of the bi-component fibers or films can undergo a graphitization step 145. Graphitization 145 generally comprises a heat treatment in an inert environment at a more elevated temperature than the carbonization temperature. Nitrogen is not used in the graphitization step 145 because it can react with carbon to form a nitride. This step can be performed with the carbonized primary component fibers or films under tension or stress.

Generally, the graphitization step 145 occurs at about 1800° C. to about 2800° C. The duration can be up to about 1 hour, with about 1 millisecond to about 15 minutes being preferred. The exact temperature and duration also depends, in part, on the acrylonitrile-containing polymer composition and the concentration of CNTs present in the composite. In some embodiments, the heat treatment can be a multi-step heat treatment.

Reference will now be made to the resultant carbon fibers and films containing CNTs and/or graphite sheets. As mentioned above, it is to be understood, for the sake of brevity and minimizing repetition of text, by extension, that all reference to CNTs is intended to include graphite sheets, whether used as a substitute for CNTs or in conjunction with CNTs. In some situations, for the sake of clarity, reference will be made to the analogous condition/property for graphite sheets in a first description, but will not be repeated throughout the rest of the text.

The final carbon fibers generally have an average diameter of about 10 nm to about 10 μm. More specifically, they can have an average diameter of about 12 nm to about 5 μm. The final carbon films generally have an average thickness of about 25 nm to about 25 μm. More specifically, the final carbon films can have an average thickness of about 50 nm to about 5 μm. There is no particular limit on the width of the films. Depending on the particular dimensions of the fibers or films, the films or fibers can be optically transparent. The CNTs are present in the final carbon fibers or films in a range of about 0.001 wt % to about 80 wt %, with about 0.01 wt % to about 5 wt % being preferable.

In exemplary embodiments, the CNTs in the final carbon fibers or films are exfoliated. That is, the CNTs are generally not found in large bundles or ropes of CNTs; and the graphite sheets are generally not found as overlapping stacks of sheets. More specifically, in these embodiments, the CNTs (and/or graphite sheets) in the final carbon fibers or films exist as individual nanotubes (and/or sheets) or as groups (and/or stacks) averaging less than 10 nanotubes (and/or sheets) per group. In some embodiments, the groups average less than 5 nanotubes. In other embodiments, groups averaging less than 3 nanotubes have been observed. Without being bound by theory, exfoliation of the nanotubes is believed to be effected in different ways. It has been found that increased concentrations of nanotubes results in greater bundling in the final carbon fibers or films. Thus, exfoliation of the CNTs can be achieved using lower concentrations of nanotubes. In addition, regular or continuous drawing during the drawing step 125 is believed to produce better exfoliation of the CNTs. By way of example, mixing a dilute dispersion (e.g., 10 milligrams of small diameter CNTs in 300 milliliters of solvent) with the acrylonitrile-containing polymer during the solution preparation step 110, followed by regular drawing during drawing step 125 can produce carbon fibers having CNTs existing either individually or in groups averaging less than 3 nanotubes.

In an advantageous feature of the processes disclosed herein, the graphitization step 145 is not necessary. In fact, even without a graphitization step, the presence of the CNTs in the acrylonitrile-containing polymer induces graphitization at the low temperatures of the carbonization step 140. Specifically, after carbonization, a crystallized graphitic region extending radially about 0.34 nanometer (nm) to about 50 nm from the wall of each CNT can be observed. With respect to the graphite sheets, the crystallized graphitic region can extend directly about 0.34 nanometer (nm) to about 50 nm from the surface of each sheet. More commonly, the crystallized graphitic region extends radially (and/or directly) about 1 nm to about 30 nm from the wall (and/or surface) of each CNT (and/or graphite sheet). In some instances, the crystallized graphitic region extends radially at least about 2 nm from the wall of each CNT. Stated another way, the presence of 1 wt % CNTs in the polymer-nanotube mixture affected the reactivity of up to about 30% of the polymer in the vicinity of the CNTs. These results are quite surprising considering the low temperature of the carbonization step 140 of the processes of the present invention.

Further, the application of tension to the fibers or films during one or more of the stabilization, carbonization, and optional graphitization steps is also believed to contribute to the crystallization of the graphitic regions surrounding the CNTs. Thus, in exemplary embodiments, tension is applied to the fibers or films during each of these steps.

In another advantageous feature of the processes disclosed herein, stabilizing and carbonizing (and optionally graphitizing) the drawn fibers or films produces carbon fibers or films having an increased tensile modulus and strength. Generally, at least an 0.5 GPa increase in tensile strength and at least a 50 GPa increase in tensile modulus can be achieved with the addition of about 1 wt % CNTs in the polymer-nanotube mixture, relative to a carbon fiber or film prepared using the same procedure but without any CNTs. For fibers or films, improvements of at least 50% in tensile strength and/or tensile modulus can be achieved with the addition of about 1 wt % CNTs in the polymer-nanotube mixture (again, relative to a carbon fiber or film prepared using the same procedure but without any CNTs).

The final carbon fibers or films can have tensile strengths of up to about 10 GPa or more, and tensile moduli of up to about 750 GPa or more. For example, carbonized carbon fibers produced from PAN and CNTs by gel extrusion can exhibit a tensile strength of up to about 6 GPa and a tensile modulus of up to about 600 GPa without undergoing a graphitization step. Further, it is also possible to obtain carbon fibers or films having higher compressive strengths than tensile strengths.

Another improvement that is observed with the carbon fibers or films of the present invention includes improved electrical conductivity. The electrical conductivity of a carbon fiber or film prepared using the processes described herein, can increase at least about 25 percent relative to that of a carbon fiber or film without CNTs. In one example, conductivities increased by more than 50 percent. Further, in some embodiments, conductivities of more than two, five, or even ten, times that of a carbon fiber or film without CNTs can be achieved.

The various embodiments of the present invention are further illustrated by the following non-limiting examples.

### EXAMPLES

### Example 1

### Islands-In-A-Sea Bi-Component Fibers

In this example, small diameter polyacrylonitrile (PAN) and PAN/carbon nanotube (CNT) composite having about 99 weight percent PAN and about 1 weight percent CNTs (99/1) fibers were processed using an island-in-a-sea bi-component cross-sectional geometry and gel spinning. The sea component polymer was subsequently removed by complete thermal degradation during stabilization and the island component was stabilized and carbonized, resulting in PAN and PAN/CNT based carbon fibers with an effective diameter of about 1 micrometer (μm) or less. As will be described in more detail in this example, PAN/CNT (99/1) based carbon fibers processed using this approach exhibited a tensile strength of about 4.5 GPa (2.5 N/tex) and tensile modulus of about 463 GPa (257 N/tex), while these values for the control PAN-based carbon fiber processed under the similar conditions were about 3.2 GPa (1.8 N/tex) and about 337 GPa (187 N/tex), respectively. Properties of these small diameter carbon fibers have also been compared to the properties of the larger diameter (i.e., greater than about 6 μm) PAN and PAN/CNT based carbon fibers.

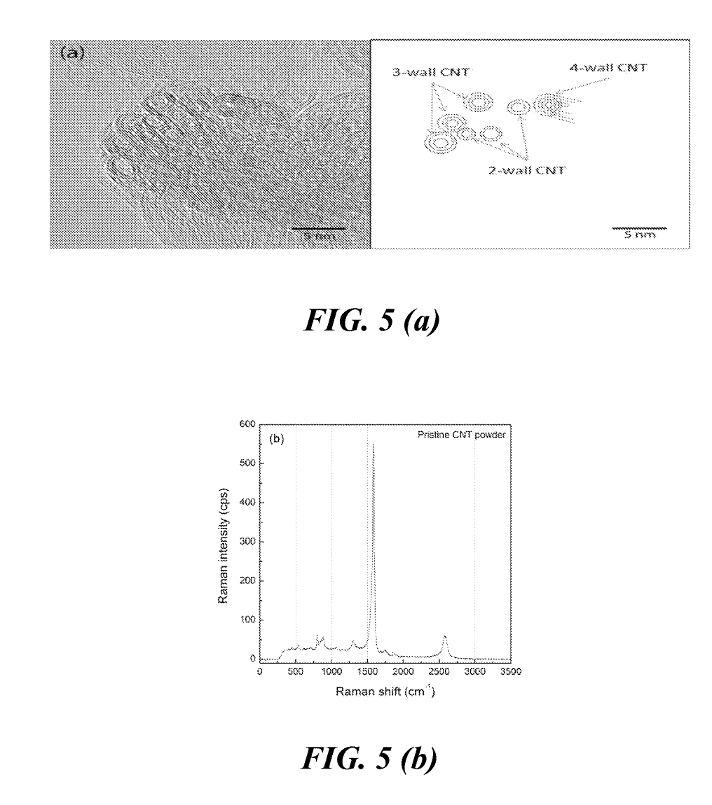

PAN, having a viscosity average molecular weight of about 250,000 grams per mole (g/mol), was obtained from Japan Exlan Company, Ltd. Carbon nanotubes (Lot # XO-021UA) were obtained from Unidym, Inc. (Houston, Tex.), and, based on thermogravimetric analysis (TGA) in air, the CNTs used in this study contained about 1.6 wt % catalytic impurities. High-resolution transmission electron microscopy (HR-TEM), as shown in FIG. 5(a), revealed that the CNTs were a mixture of double-wall and triple-wall carbon nanotubes with few multi-wall carbon nanotubes. The Raman spectrum of the CNTs, as shown in FIG. 5(b), has no radial breathing mode. Poly(methyl metharcrylate) (PMMA), having a molecular weight of about 85,000 to about 150,000 g/mol, and obtained from Cyro Industries (Orange, Conn.), was used as the sacrificial “sea” component. Dimethyl formamide (DMF) was obtained from Sigma-Aldrich, Co.

The CNTs were dispersed in DMF at a concentration of about 40 milligrams per liter (mg/L) for about 24 hours under sonication (Branson 3510R-MT, 100 W, 42 kHz) at room temperature. About 14.85 grams of PAN was dissolved in about 100 mL DMF at about 80° C. An optically homogeneous CNT/DMF dispersion was added to the PAN/DMF solution. Any excess amounts of solvent were evaporated by vacuum distillation at about 80° C., while stifling, to obtain the desired solution concentration, which was about 15 grams of solids per 100 mL of solvent. The solution for the sea component was prepared by dissolving about 55 grams of PMMA in about 100 mL DMF at about 150° C.

The islands-in-a-sea fiber was processed using a spinneret having a diameter of about 250 μm. The bi-component spinning apparatus was designed similar to what is depicted in FIG. 2. The temperature of both solution reservoirs (i.e., the island reservoir, which contained either PAN or PAN/CNT, and the sea reservoir, which contained PMMA) was maintained at about 120° C., while the spinneret was maintained at about 140° C. The volumetric flow rates of both the sea and island components were about 1.5 cubic centimeters per minute (cm³/min), which is equivalent to a linear jet speed of about 61 meters per minute (m/min) based on the spinneret diameter. The solution was spun into a methanol bath maintained at about −50° C. The air gap between the spinneret and the methanol bath was kept at about 5 cm. The as-spun fibers were taken up at about 200 m/min and kept immersed in the methanol bath at about −50° C. for several days to ensure gelation of the island component.

The gel bi-component fiber was drawn in several stages at about 110° C., about 150° C., and about 170° C., using an in-line heater. The total draw ratio of the PAN and PAN/CNT gel fibers with the PMMA sea component was about 10. This did not include the 3.3 draw ratio in the methanol bath during the spinning step.

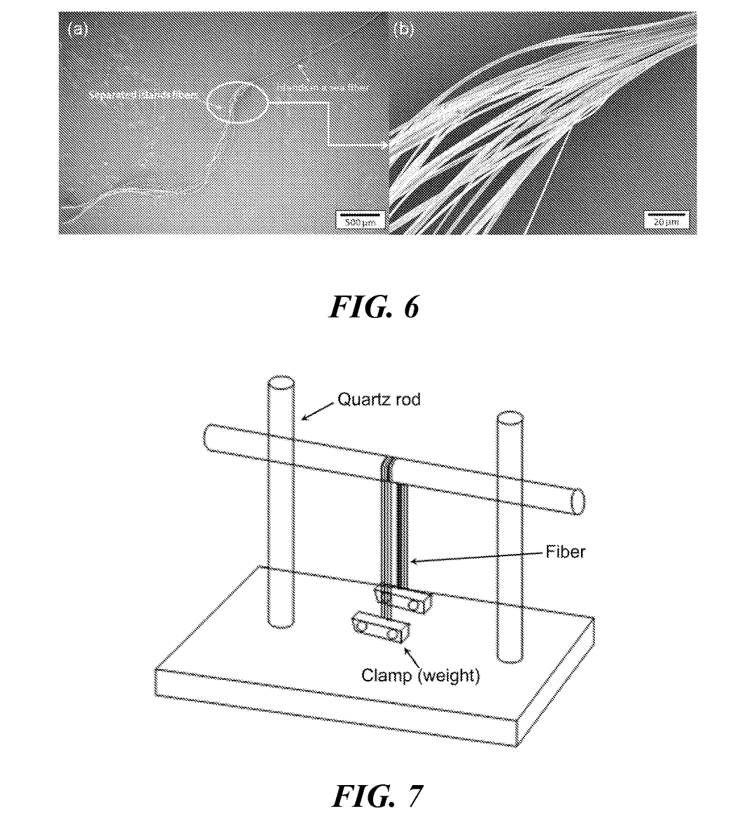

The drawn fibers were subsequently vacuum dried at about 70° C. for about 3 days. FIG. 6 provides scanning electron microscope (SEM) images of the precursor islands-in-a-sea fiber with and without sea component separation. The PMMA sea component can be removed by dissolving in nitromethane.

The dried islands-in-a-sea precursor fibers (without removing the sea component PMMA) were stabilized in a box furnace (Lindberg, 51668-HR Box Furnace 1200C, Blue M Electric) in air by hanging over a quartz rod using two clamping steel blocks as illustrated in FIG. 7. Based on the island fibers' cross-sectional area (PAN or PAN/CNT), 10 megaPascals (MPa) of initial stress was applied. The fibers were heated from room temperature to about 285° C. in air at a heating rate of about 1 degree Celsius per minute (° C./min) and held at about 285° C. for about 4 hours. This was followed by heating to about 330° C. at a heating rate of about 1° C./min and holding at about 330° C. for about 2 hours. The stabilized fibers were then cooled to room temperature over a period of several hours. During this stabilization, the sea component (PMMA) was completely burned off.

The stabilized island PAN and PAN/CNT fibers were subsequently carbonized in argon by heating from room temperature at a rate of about 5° C./min to about 1200° C., and holding at about 1200° C. for about 5 minutes.

Tensile tests were conducted on multi-filament specimens. The multi-filament specimens were prepared and tested using an RSA III solids analyzer (Rheometric Scientific, Co.) at a gauge length of about 6 mm and a cross head speed of about 0.1 percent per second (%/s). The data were not corrected for machine compliance. The tensile fractured specimens were sputter coated with gold and examined by SEM (LEO 1530 operated at 10 kV) to determine the effective cross-sectional area. To further ensure an accurate cross-sectional area determination, the SEM was calibrated using a standard sample (301BE, EMS, Co., Hatfield, Pa.). The cross-sectional area of the fiber was determined using image analysis software (UTHSCSA Image Tool version 3.0, University of Texas Health Science Center, San Antonio, Tex.).

Wide-angle X-ray diffraction (WAXD) patterns were obtained on multifilament bundles using a Rigaku MicroMax-002 diffractometer (X-ray wavelength, λ=0.15418 nm) equipped with a Rigaku R-axis IV++ detection system. The diffraction patterns were analyzed using AreaMax V. 1.00 and MDI Jade 6.1. Orientation (f₀₀₂) and crystal size (L₀₀₂ and L₁₀) of the carbonized graphitic structure were determined. Raman spectra of the carbonized fibers were collected in the backscattering geometry using a Holoprobe Research 785 Raman Microscope made by Kaiser Optical System using a 785 nm excitation laser equipped with a polarizer and analyzer parallel to each other (vv mode). The fibers were placed parallel to the polarizer and analyzer in the Raman microscope.

HR-TEM was performed using a JEOL 4000 EX transmission electron microscope operated at 400 kV. Carbon fiber samples were prepared for HR-TEM analysis by first grinding fibers using a jade mortar and pestle. The ground fibers were placed in ethanol and sonicated for about 15 minutes to further disintegrate the fiber fragments into thin sections. A droplet of this dispersion was placed on a TEM grid (Electron Microscopy Sciences, Cat. # 200C-LC), and dried for analysis.

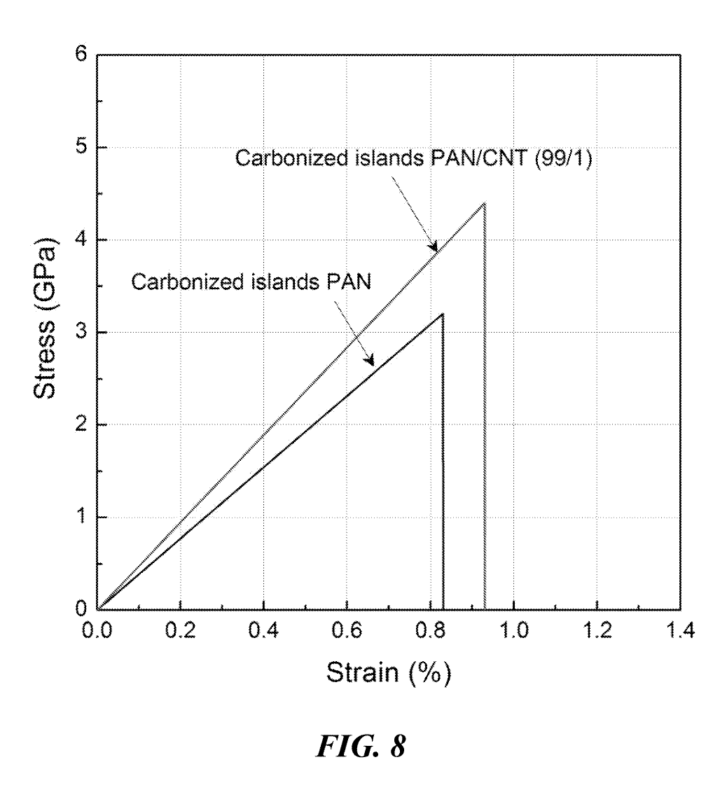

The tensile properties of the carbonized island PAN and PAN/CNT (99/1) fibers are listed in Table 1. For comparison, the tensile properties of larger-diameter carbon fibers, processed from gel-spun PAN- and PAN/CNT-based fibers, are also listed in Table 1. FIG. 8 illustrates representative stress-strain curves for the carbonized PAN and PAN/CNT island fibers.

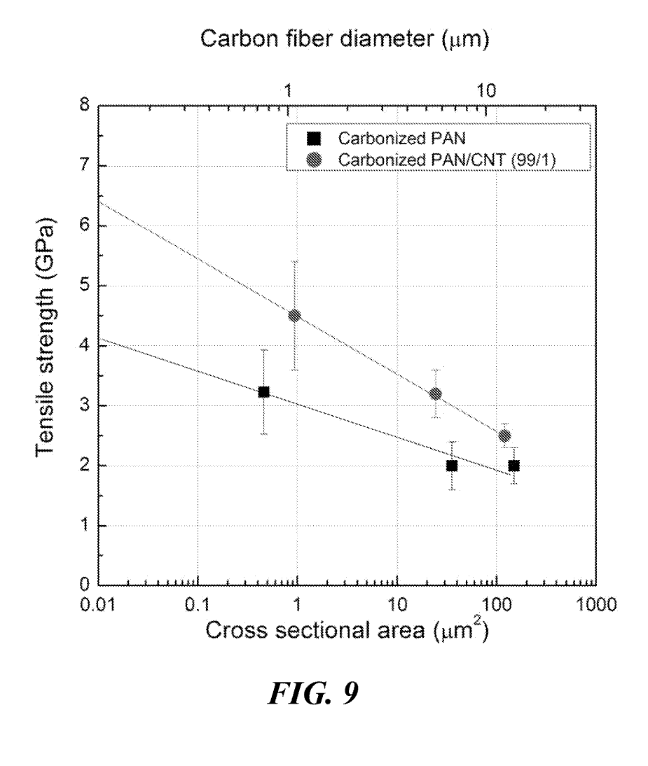

The tensile strengths of PAN and PAN/CNT-based carbon fibers having different cross-sectional areas indicate that there is an increase in strength accompanied by a reduction in cross-sectional area, as shown in FIG. 9. The data confirms two points: (a) At a given cross-sectional area, tensile strength of PAN/CNT based carbon fibers containing about 1 wt % CNT in the precursor can be about 25 to about 60% higher than the corresponding PAN based carbon fiber, and (b) tensile strength increases with decreasing cross-sectional area.

TABLE 1
Tensile properties of carbonized island and large diameter
PAN and PAN/CNT (99/1) fibers.

| | | Carbonized island fibers | | Carbonized fibers^{†} | | Carbonized fibers^{‡} | |
|---|---|---|---|---|---|---|---|
| | | | PAN/CNT | | PAN/CNT | | PAN/CNT |
| | | PAN | (99/1) | PAN | (99/1) | PAN | (99/1) |
| Linear density | | 8.3 × 10⁻⁴ | 1.7 × 10⁻³ | 6.4 × 10⁻² | 4.4 × 10⁻² | 0.27 | 0.22 |
| (tex) | | | | | | | |
| Cross-sectional | | 0.46 | 0.94 | 35.6 | 24.4 | 149.6 | 120.8 |
| area (μm²) | | | | | | | |
| Tensile | (GPa) | 3.2 ± 0.7 | 4.5 ± 0.9 | 2.0 ± 0.4 | 3.2 ± 0.4 | 2.0 ± 0.2 | 2.5 ± 0.2 |
| strength | (N/ | 1.78 ± 0.39 | 2.5 ± 0.5 | 1.1 ± 0.2 | 1.8 ± 0.2 | 1.1 ± 0.1 | 1.4 ± 0.1 |
| | tex) | | | | | | |
| Tensile | (GPa) | 337 ± 38 | 463 ± 41 | 302 ± 32 | 450 ± 49 | 265 ± 23 | 342 ± 16 |
| modulus | (N/ | 187 ± 21 | 257 ± 23 | 168 ± 18 | 250 ± 27 | 147 ± 13 | 190 ± 9 |
| | tex) | | | | | | |

| | | | | | | |
|---|---|---|---|---|---|---|
| Strain to failure | 0.85 ± 0.13 | 0.96 ± 0.23 | 0.68 ± 0.04 | 0.72 ± 0.05 | 0.63 ± 0.08 | 0.75 ± 0.04 |
| (%) | | | | | | |

†Precursor fiber diameter was about 12 μm.
‡Precursor fiber diameter was about 20 μm.

The tensile modulus of PAN-based carbon fibers increases monotonically with carbonization temperature, while tensile strength reaches a maximum value at about 1500° C. The modulus of small-diameter carbonized gel-spun PAN fibers is higher than that for commercially-available fibers carbonized at the same temperature. For the corresponding PAN/CNT-based carbon fiber, the modulus is substantially higher. These trends can be seen in Table 1. This represents contributions coming from gel spinning, CNTs, as well as from the small cross-sectional area of the fibers.

One advantage of PAN-based carbon fibers over pitch-based carbon fiber or wholly CNT carbon fibers is in compressive strength. PAN-based carbon fibers are strong in tension as well as in compression, and therefore these are the only carbon fibers used in those structural composites where compressive strength is also a requirement. The recoil test, as described in Kozey et al. (“Compressive Behavior of Materials 2. High-Performance Fibers”, 1995, Journal of Materials Research, 10, 1044) can give an indirect measure of the compressive strength of an elastic fibers. When an elastic fiber fails in tension, it will also fail in compression if its tensile strength is higher than its compressive strength. The tensile stress wave propagates through the fiber to the clamp and recoils as a compressive stress wave. If there are no energy losses in the fiber, then the magnitude of the compressive stress wave is the same as that of the tensile stress. About 50% of the small-diameter carbon fiber processed from gel-spun PAN/CNT fibers did not fail in compression when they failed in tension. These observations suggest that carbon fibers made from small-diameter gel-spun PAN/CNT have compressive strengths comparable to, or higher than, their tensile strengths.

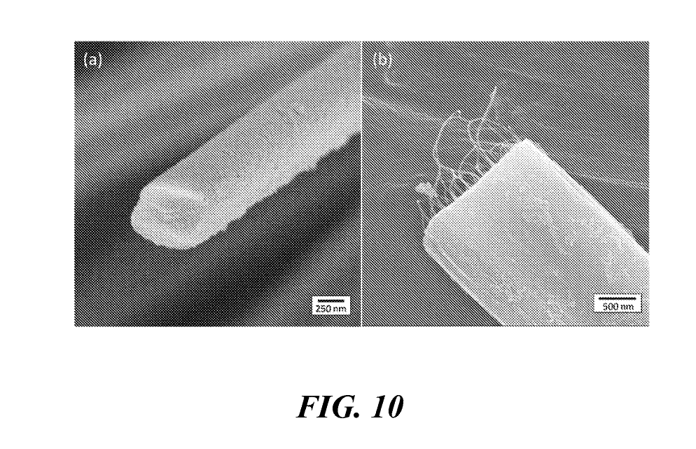

CNT-containing carbon fibers have marginally smaller d-spacing and larger crystal size along the fiber axis (L₁₀) as compared to the carbonized control PAN fibers. This is evidenced by the data in Table 2. The fracture surfaces of the PAN/CNT-based carbon fibers show fibrils with about 20 nm to about 50 nm diameters, which can be seen in FIG. 10(b). These fibrils represent PAN that has been graphitized around the CNTs. The fracture behavior of the small-diameter gel-spun PAN, as seen in FIG. 10(a), is typical of PAN based carbon fibers.

TABLE 2
Structural parameters of carbonized islands fibers

| | | Carbonized islands |
|---|---|---|
| | Carbonized islands PAN | PAN/CNT (99/1) |
| d-spacing₍₀₀₂₎ (nm) | 0.357 | 0.356 |
| L₍₀₀₂₎^{a} (nm) | 1.3 | 1.3 |
| L₍₁₀₎^{b} (nm) | 1.8 | 2.1 |

^{a}Crystal size from equatorial scan
^{b}Crystal size from meridional scan

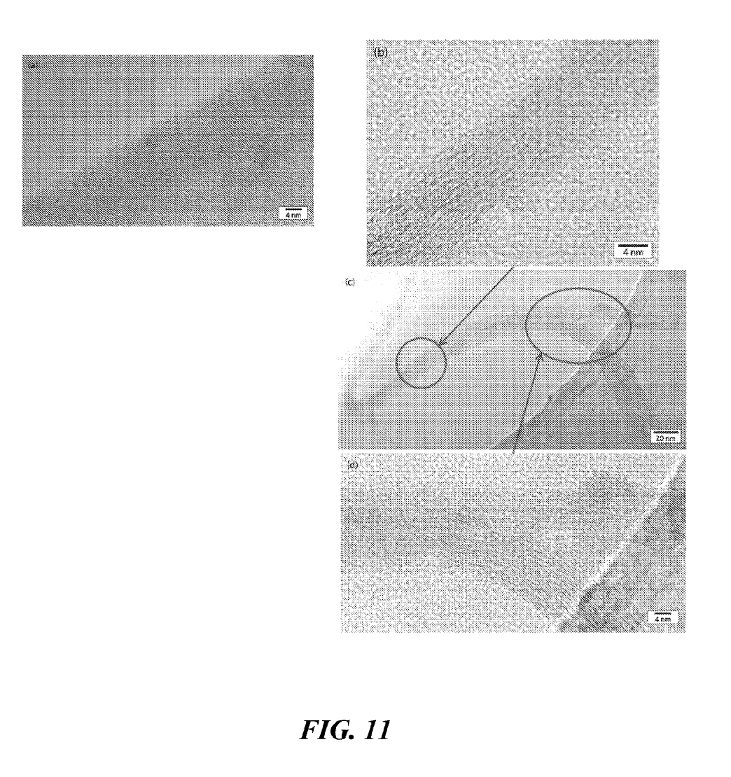

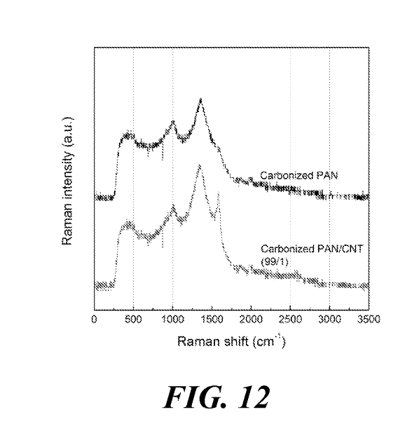

FIG. 11 includes HR-TEM images of carbonized PAN and PAN/CNT fibers. While the carbonized PAN fibers shown in FIG. 11(a) exhibit a less ordered carbon structure, the fibril structure in the carbonized PAN/CNT, shown in FIGS. 11(b)-11(d), reveals a highly ordered graphitic structure. The structure of the PAN/CNT-based carbon fibers is, however, not simply CNTs added to the carbonized PAN. Rather, the presence of CNTs affects the carbonization of PAN. PAN in the immediate vicinity of CNTs stabilizes and carbonizes differently than the PAN farther away from the nanotubes. When carbonized at about 1200° C., gel-spun PAN does not develop a graphitic structure. However, when carbonized at this temperature and at the same stress, gel-spun PAN/CNT containing about 1 wt % CNTs exhibited a significant graphitic peak in the Raman spectra, as seen in FIG. 12. This graphitic peak is not due to the presence of CNT, but is a result of PAN conversion to a graphitic structure in the presence of CNT. These graphitic fibril structures contribute to the enhancement in tensile strength and modulus.

In this example, very fine continuous PAN/CNT precursor fibers were successfully processed by bi-component and gel spinning. The subsequent stabilization and carbonization resulted in carbon fibers with an effective diameter of about 1 μm, and average tensile strength of about 4.5 GPa (about 2.5 N/tex) and average tensile modulus of about 463 GPa (about 257 N/tex).

The embodiments of the present invention are not limited to the particular formulations, process steps, and materials disclosed herein as such formulations, process steps, and materials may vary somewhat. Moreover, the terminology employed herein is used for the purpose of describing exemplary embodiments only and the terminology is not intended to be limiting since the scope of the various embodiments of the present invention will be limited only by the appended claims and equivalents thereof. For example, temperature, stress, and time parameters may vary depending on the particular materials used.

Therefore, while embodiments of this disclosure have been described in detail with particular reference to exemplary embodiments, those skilled in the art will understand that variations and modifications can be effected within the scope of the disclosure as defined in the appended claims. Accordingly, the scope of the various embodiments of the present invention should not be limited to the above discussed embodiments, and should only be defined by the following claims and all equivalents.

All patents and other references cited herein are incorporated by reference as if fully set forth herein.

1. A method of making a carbon fiber, the method comprising:
extruding a solution of a primary component and a solution of a secondary component through a bi-component extrusion apparatus to form a bi-component polymer fiber comprising a primary component and a secondary component; and
drawing the bi-component polymer fiber to form a drawn bi-component polymer fiber;
wherein the primary component comprises an acrylonitrile-containing polymer.

2. The method of claim 1, further comprising stabilizing the drawn bi-component polymer fiber.

3. The method of claim 2, further comprising separating the primary component from the secondary component of the drawn or stabilized bi-component polymer fiber.

4. The method of claim 1, further comprising carbonizing the primary component of the bi-component polymer fiber.

5. The method of claim 4, further comprising graphitizing the carbonized primary component of the bi-component polymer fiber.

6. The method of claim 1, wherein the extruding comprises gel-extruding or solution-extruding.

7. (canceled)

8. The method of claim 1, wherein the drawn bi-component polymer fiber has an average diameter of about 100 nanometers to about 1 millimeter.

9. The method of claim 2, wherein the stabilizing comprises stabilizing the drawn polymer fiber under tension, stabilizing the drawn polymer fiber in an oxidizing environment, and/or stabilizing the drawn polymer fiber at about 200 degrees Celsius to about 400 degrees Celsius for less than or equal to about 36 hours.

10. (canceled)

11. (canceled)

12. The method of claim 3, wherein the separating comprises dissolving the secondary component from the drawn or stabilized bi-component polymer fiber, sonicating the drawn or stabilized bi-component polymer fiber to reduce any interfacial interactions between the primary component and secondary component, heating to melt the second component away from the drawn or stabilized bi-component polymer fiber, heating to burn the second component away from the drawn or stabilized bi-component polymer fiber, or a combination comprising at least two of the foregoing.

13. The method of claim 3, wherein the separating and the stabilizing occur simultaneously.

14. The method of claim 4, wherein the carbonizing comprises carbonizing the stabilized polymer fiber under tension, carbonizing the stabilized polymer fiber in an inert environment, and/or carbonizing the stabilized polymer fiber at about 500 degrees Celsius to about 1800 degrees Celsius for less than or equal to about 2 hours.

15. (canceled)

16. (canceled)

17. The method of claim 5, wherein the graphitizing comprises graphitizing the carbonized polymer fiber under tension, graphitizing the carbonized polymer fiber in a non-nitrogen-containing inert environment, and/or graphitizing the carbonized polymer fiber at about 1800 degrees Celsius to about 2800 degrees Celsius for less than or equal to about 1 hour.

18.-21. (canceled)

22. A method of making a carbon fiber or film, the method comprising:
contacting carbon nanotubes (CNT) with an acrylonitrile-containing polymer to form a primary component solution;
extruding the primary component solution and a secondary component solution to form a bi-component polymer-CNT fiber or film precursor comprising a primary component and a secondary component; and
drawing the bi-component polymer-CNT fiber or film precursor to form a drawn bi-component polymer-CNT fiber or film.

23. The method of claim 22, further comprising stabilizing the drawn bi-component polymer-CNT fiber or film.

24. The method of claim 23, further comprising separating the primary component from the secondary component of the drawn or stabilized bi-component polymer-CNT fiber or film.

25. The method of claim 22, further comprising carbonizing the primary component of the bi-component polymer-CNT fiber or film.

26. The method of claim 25, further comprising graphitizing the carbonized primary component of the bi-component polymer-CNT fiber or film.

27.-30. (canceled)

31. The method of claim 22, wherein the CNT comprise about 0.001 weight percent to about 40 weight percent of the bi-component polymer-CNT fiber or film precursor, based on a total weight of the bi-component polymer-CNT fiber or film precursor, or wherein the CNT comprise about 0.001 weight percent to about 80 weight percent of the carbon fiber or film, based on a total weight of the carbon fiber or film.

32. The method of claim 22, wherein the drawn polymer-CNT fiber has an average diameter of about 100 nanometers to about 1 millimeter, or wherein the drawn polymer-CNT film has an average thickness of about 50 nanometers to about 50 micrometers.

33. The method of claim 23, wherein the stabilizing comprises stabilizing the drawn polymer-CNT fiber or film under tension, stabilizing the drawn polymer-CNT fiber or film in an oxidizing environment, and/or stabilizing the drawn polymer-CNT fiber or film at about 200 degrees Celsius to about 400 degrees Celsius for less than or equal to about 36 hours.

34. (canceled)

35. (canceled)

36. The method of claim 24, wherein the separating comprises dissolving the secondary component from the drawn or stabilized bi-component polymer-CNT fiber or film, sonicating the drawn or stabilized bi-component polymer-CNT fiber or film to reduce any interfacial interactions between the primary component and secondary component, heating to melt the second component away from the drawn or stabilized bi-component polymer-CNT fiber or film, heating to burn the second component away from the drawn or stabilized bi-component polymer-CNT fiber or film, or a combination comprising at least two of the foregoing.

37. The method of claim 24, wherein the separating and the stabilizing occur simultaneously.

38. The method of claim 25, wherein the carbonizing comprises carbonizing the stabilized polymer-CNT fiber or film under tension, carbonizing the stabilized polymer-CNT fiber or film in an inert environment, and/or carbonizing the stabilized polymer-CNT fiber or film at about 500 degrees Celsius to about 1800 degrees Celsius for less than or equal to about 2 hours.

39. (canceled)

40. (canceled)

41. The method of claim 26, wherein the graphitizing comprises graphitizing the carbonized polymer-CNT fiber or film under tension, graphitizing the carbonized polymer-CNT fiber in a non-nitrogen-containing inert environment, and/or graphitizing the carbonized polymer-CNT fiber at about 1800 degrees Celsius to about 2800 degrees Celsius for less than or equal to about 1 hour.

42. (canceled)

43. (canceled)

44. The method of claim 22, wherein the carbon fiber has an average diameter of about 10 nanometers to about 10 micrometers, or wherein the carbon film has an average thickness of about 25 nanometers to about 25 micrometers.

45. (canceled)

46. The method of claim 22, wherein the CNT in the carbon fiber or film are exfoliated.

47. The method of claim 22, wherein the carbon fiber or film comprises a crystallized graphitic region radially extending about 0.34 nanometers to about 50 nanometers from a wall of each CNT.

48. The method of claim 47, wherein the crystallized graphitic region radially extends at least about 2 nanometers from the wall of each CNT.

49. The method of claim 22, wherein the carbon fiber or film has an electrical conductivity at least 25% higher than that of a carbon fiber or film comprising no CNT, wherein the carbon fiber or film has at least an 0.5 GPa greater tensile strength than a carbon fiber or film produced without the CNT, and/or wherein the carbon fiber or film has at least a 50 GPa greater tensile modulus than a carbon fiber or film produced without the CNT.

50. The method of claim 22, wherein the extruding comprises gel-extruding or solution-extruding.

51.-85. (canceled)

86. A method of making a carbon fiber or film, the method comprising:
contacting graphite sheets with an acrylonitrile-containing polymer to form a primary component solution;
extruding the primary component solution and a secondary component solution to form a bi-component polymer-graphite sheet fiber or film precursor comprising a primary component and a secondary component; and
drawing the bi-component polymer-graphite sheet fiber or film precursor to form a drawn polymer-graphite sheet fiber or film.

87. The method of claim 86, further comprising stabilizing the drawn bi-component polymer-graphite sheet fiber or film.

88. The method of claim 87, further comprising separating the primary component from the secondary component of the drawn or stabilized bi-component polymer-graphite sheet fiber or film.

89. The method of claim 86, further comprising carbonizing the primary component of the bi-component polymer-graphite sheet fiber or film.

90. The method of claim 89, further comprising graphitizing the carbonized primary component of the bi-component polymer-graphite sheet fiber or film.

91. The method of claim 86, wherein the graphite sheets have an average width of about 0.5 nanometers to about 100 nanometers, an average thickness of about 0.5 nanometers to about 25 nanometers, and/or an average length of greater than or equal to about 10 nanometers.

92.-149. (canceled)

150. A carbon fiber or film formed from carbon nanotubes (CNT) and an acrylonitrile-containing polymer or from graphite sheets and an acrylonitrile-containing polymer, the carbon fiber or film comprising:
an average diameter of about 10 nanometers to about 10 micrometers for the carbon fiber, or an average thickness of about 25 nanometers to about 25 micrometers for the carbon film; and
a crystallized graphitic region radially extending about 0.34 nanometers to about 50 nanometers from a wall of each CNT or graphite sheet,
wherein the carbon fiber or film comprises a tensile strength at least about 0.65 GPa greater than a carbon fiber or film formed without the CNT or the graphite sheets; and
wherein the carbon fiber or film comprises a tensile modulus at least about 75 GPa greater than a carbon fiber film formed without the CNT or the graphite sheets.

151.-189. (canceled)
